(19) United States
(12) Patent Application Publication
(10) Pub. No.: US 2017/0322810 A1
(43) Pub. Date: Nov. 9, 2017

(54) HYPERVECTOR-BASED BRANCH PREDICTION

(71) Applicant: QUALCOMM Incorporated, San Diego, CA (US)

(72) Inventor: Sandeep Suresh NAVADA, Raleigh, NC (US)

(21) Appl. No.: 15/587,371

(22) Filed: May 4, 2017

Related U.S. Application Data
(60) Provisional application No. 62/332,734, filed on May 6, 2016.

(51) Int. Cl. G06F 9/38; G06F 9/30

(52) U.S. Cl. CPC G06F 9/3806; G06F 9/3001; G06F 9/30036

(57) ABSTRACT

Systems and methods are directed to hypervector-based branch prediction. For a branch instruction whose direction is to be predicted, a taken distance between a current hypervector and a taken hypervector and a not-taken distance between the current hypervector and a not-taken hypervector is determined, wherein the current hypervector comprises an encoding of context of the branch instruction, the taken hypervector comprises an encoding of context of taken branch instructions and the not-taken hypervector comprises an encoding of context of not-taken branch instructions. If the taken distance is less than the not-taken distance, the branch instruction is predicted to be taken, or on the other hand, if the not-taken distance is less than the taken distance, the branch instruction is predicted to be not-taken.

### CLAIM OF PRIORITY UNDER 35 U.S.C. §119

The present application for patent claims the benefit of Provisional Patent Application No. 62/332,734 entitled “HYPERVECTOR-BASED BRANCH PREDICTION” filed May 6, 2016, pending, and assigned to the assignee hereof and hereby expressly incorporated herein by reference in its entirety.

### FIELD OF DISCLOSURE

Disclosed aspects relate to branch predictions in processing systems. More specifically, exemplary aspects are directed to hypervector-based branch prediction.

### BACKGROUND

Processing systems may employ instructions which cause a change in control flow, such as branch instructions. If the direction of a branch instruction depends on how a condition evaluates, the branch instruction is referred to as a conditional branch instruction. However, the evaluation of the condition may not be known until instruction processing proceeds several cycles into an instruction pipeline. To avoid stalling the pipeline until the evaluation is known, the processor may employ branch prediction mechanisms to predict the direction of the conditional branch instruction early in the pipeline. Based on the prediction, the processor can speculatively fetch and execute instructions from a predicted address in one of two paths—a “taken” path which starts at the branch target address, or a “not-taken” path which starts at the next sequential address after the conditional branch instruction.

When the condition is evaluated and the actual branch direction is determined, if the actual branch direction matches that of the predicted branch direction, the conditional branch instruction is said to have been correctly predicted, and if not, the conditional branch instruction is said to have been incorrectly predicted or mispredicted. If a conditional branch instruction is mispredicted (i.e., execution followed a wrong path) the speculatively fetched instructions may be flushed from the pipeline, and new instructions in a correct path may be fetched from the correct next address. Accordingly, improving accuracy of branch prediction for conditional branch instructions mitigates penalties associated with mispredictions and execution of wrong path instructions, and correspondingly improves performance and energy utilization of a processing system.

Conventional branch prediction mechanisms may include complex circuitry, e.g., directed to one or more state machines which may be trained with a history of evaluation of past and current branch instructions. In this regard, TAGE predictors are gaining popularity for their ability to make predictions of increased accuracy by taking into account contexts and history associated with branch instructions. TAGE (or simply, “Tage”) is an abbreviation of (partially) TAgged GEometric history length, which relies on a default branch prediction mechanism without tags for entries of a branch history table, for example, and one or more partially tagged prediction components which are indexed using different history lengths for index computation. These history lengths form a geometric series. The prediction provided by a Tage predictor is based either on a tag match on one of the tagged predictor components or by the default branch prediction mechanism. In case there are multiple hits among the various prediction components, the prediction provided by the tag matching the longest history length may be used.

But such branch prediction mechanisms involving a Tage predictor or other alternative branch predictors known in the art can be inaccurate in some situations, e.g., wherein their predictions disagree with a strong statistical bias of some branch instructions. For example, if a branch instruction is statistically seen to be taken 90% of the time the branch instruction is executed, then predicting the branch instruction to always be consistent with its statistical bias (either taken or not-taken) would only result in the branch instruction being mispredicted 10% of the time. Thus, if a conventional branch prediction mechanism (e.g., involving a Tage predictor) generates predictions for the branch instruction which are incorrect more than 10% of the time, then that branch prediction mechanism would disagree with the statistical bias of the branch instruction more than 10% of the time. Thus, the conventional branch prediction mechanism may have an overall accuracy which may be worse than the prediction accuracy which may be achieved by simply following the branch instruction's statistical bias each time the branch instruction is executed. Branch prediction mechanisms such as the Tage predictors are observed to be inefficient in predicting statistically biased branch instructions, because the statistical bias (e.g., taken or not-taken) of the statistically biased branch instructions are not necessarily correlated with history information, such as a global history. To capture or handle these types of statistical biased branches, various types of statistical correctors may be used in conjunction with a Tage predictor, as explained with reference to FIG. 1 below.

FIG. 1 shows a conventional processing system 100, for which branch prediction unit 102 is specifically illustrated. Branch prediction unit 102 may generally be employed, e.g., in a fetch stage of an instruction's processing in a pipeline (not specifically illustrated) of processing system 100 for obtaining the predicted direction of branch instructions which are fetched.

In the example shown, branch prediction unit 102 may include Tage predictor 104 (and/or some other alternative branch prediction mechanism known in the art) as well as statistical corrector 106. Branch prediction unit 102 is provided with context 103 related to branch instructions, wherein the context may include one or more of a program counter (PC) value of the branch instructions, information from a global history register (GHR), local history register (LHR), path history, etc., as known in the art. An intermediate prediction 105 is generated by Tage predictor 104 based on context 103.

Context 103 is also provided to statistical corrector 106. Statistical corrector 106 may be implemented in various manners which are known in the art (e.g., there may be table with statistical bias based prediction for each branch instruction which may be indexed using a hash of some or all of the information included in context 103). For statistically biased branch instructions, if the prediction generated by statistical corrector 106 disagrees with or mismatches intermediate prediction 105, then intermediate prediction 105 may be overridden to generate the overall prediction 107 (e.g., taken or not-taken) of branch predictor 102 (otherwise, if the prediction generated by statistical corrector 106 agrees with or matches intermediate prediction 105 then either one of the two predictions, which are effectively the same, may be provided as the overall prediction 107).

However, there may be significant design penalties in implementing statistical corrector 106. For instance, statistical corrector 106 may involve large silicon real estate penalties (e.g., in the implementation of the above-described lookup table, for example), in order to achieve acceptable accuracy in predicting statistically biased branch instructions. Conventional implementations of statistical correctors are also seen to be inefficient, complex, and involving long latencies.

Accordingly, there is a need in the art for efficient and high performance branch prediction techniques which avoid the drawbacks of conventional approaches described above.

### SUMMARY

Exemplary aspects of the invention are directed to systems and methods for efficient branch prediction techniques including a hypervector-based branch prediction. An exemplary branch prediction mechanism is designed to include a current hypervector, a taken hypervector and a not-taken hypervector. The context of a branch instruction is used in computing the current hypervector. A taken distance representing a distance (e.g., a Hamming distance) is calculated between the current hypervector and the taken hypervector. Similarly, a not-taken distance representing the distance between the current hypervector and the not-taken hypervector is also calculated. If the taken distance is less than the not-taken distance, the branch instruction is predicted to be taken, or on the other hand, if the not-taken distance is less than the taken distance, the branch instruction is predicted to be not-taken.

For example, an exemplary aspect is directed to a hypervector-based branch prediction method. For a branch instruction whose direction is to be predicted, a taken distance between a current hypervector and a taken hypervector and a not-taken distance between the current hypervector and a not-taken hypervector is determined, wherein the current hypervector comprises an encoding of context of the branch instruction, the taken hypervector comprises an encoding of context of taken branch instructions and the not-taken hypervector comprises an encoding of context of not-taken branch instructions. If the taken distance is less than the not-taken distance, a prediction of taken is generated for the branch instruction, or if the not-taken distance is less than the taken distance, a prediction of not-taken is generated for the branch instruction.

Another exemplary aspect is directed to an apparatus comprising a hypervector-based branch predictor. The hypervector-based branch predictor comprises a current hypervector comprising an encoding of context of a branch instruction whose direction is to be predicted, a taken hypervector comprising an encoding of context of taken branch instructions, and a not-taken hypervector comprising an encoding of context of not-taken branch instructions. The hypervector-based branch predictor is configured to determine a taken distance between the current hypervector and the taken hypervector and a not-taken distance between the current hypervector and the not-taken hypervector; and generate a prediction of taken for the branch instruction if the taken distance is less than the not-taken distance, or a prediction of not-taken for the branch instruction if the not-taken distance is less than the taken distance

Yet another exemplary aspect is directed to a non-transitory computer readable storage medium comprising code, which, when executed by a processor, causes the processor to perform operations for hypervector-based branch prediction. The non-transitory computer readable storage medium comprises, for a branch instruction whose direction is to be predicted, code for determining a taken distance between a current hypervector and a taken hypervector and a not-taken distance between the current hypervector and a not-taken hypervector, wherein the current hypervector comprises an encoding of context of the branch instruction, the taken hypervector comprises an encoding of context of taken branch instructions and the not-taken hypervector comprises an encoding of context of not-taken branch instructions; and code for generating a prediction of taken for the branch instruction if the taken distance is less than the not-taken distance, or a prediction of not-taken for the branch instruction if the not-taken distance is less than the taken distance.

### BRIEF DESCRIPTION OF THE DRAWINGS

The accompanying drawings are presented to aid in the description of aspects of the invention and are provided solely for illustration of the aspects and not limitation thereof.

FIG. 1 illustrates branch prediction mechanisms in a conventional processing system.

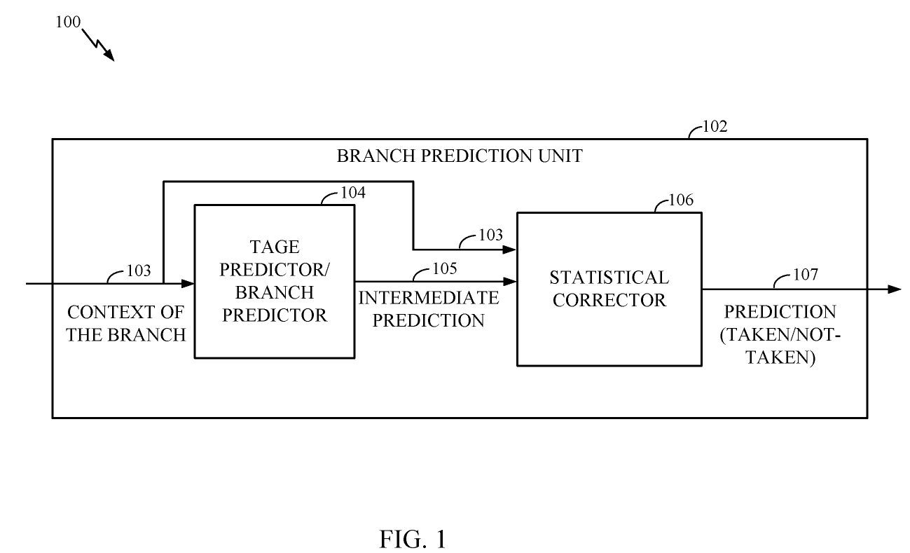

FIG. 2 illustrates an exemplary hypervector-based branch prediction mechanism according to aspects of this disclosure.

FIG. 3A illustrates an exemplary flowchart showing a branch prediction method using a hypervector-based branch prediction mechanism, according to aspects of this disclosure.

FIG. 3B illustrates an exemplary flowchart of updating the hypervector-based branch prediction mechanism, according to aspects of this disclosure.

FIG. 4 depicts an exemplary computing device in which an aspect of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In exemplary aspects, a hypervector-based branch prediction mechanism is provided. The hypervector-based branch prediction mechanism may be used to capture and utilize complex patterns related to the context of branch instructions. In exemplary aspects, the hypervector-based branch prediction mechanism may be used in addition to or in place of other branch predictors. For instance, the exemplary hypervector-based branch prediction mechanism may be used in place of the above-described statistical corrector and in conjunction with other branch predictors such as a Tage predictor in optional aspects.

Hypervectors are mathematical abstractions of cognitive computations. Hypervectors comprise very large vectors, e.g., with a large number of elements or bits (e.g., hypervectors may be designed to hold 512 or more bits, and in some cases even 10,000 or more bits). Some designs involving hypervectors are seen in applications such as artificial intelligence, language recognition, text classification, gesture recognition, etc., to relatively large information content. In exemplary aspects, hypervector-based branch prediction mechanisms are designed to encode context information in multiple dimensions, the context information related to branch instructions.

For example, an exemplary branch prediction mechanism comprises three hypervectors, namely, a current hypervector, a taken hypervector and a not-taken hypervector. The context of a branch instruction is encoded in the current hypervector. The taken hypervector effectively encodes information pertaining to taken branch instructions and the not-taken hypervector effectively encodes information pertaining to not-taken branch instructions. A taken distance representing a distance (e.g., a Hamming distance) is calculated between the current hypervector and the taken hypervector. Similarly, a not-taken distance representing the distance between the current hypervector and the not-taken hypervector is also calculated. If the taken distance is less than the not-taken distance, the branch instruction is predicted to be taken, or on the other hand, if the not-taken distance is greater than the taken distance, the branch instruction is predicted to be not-taken.

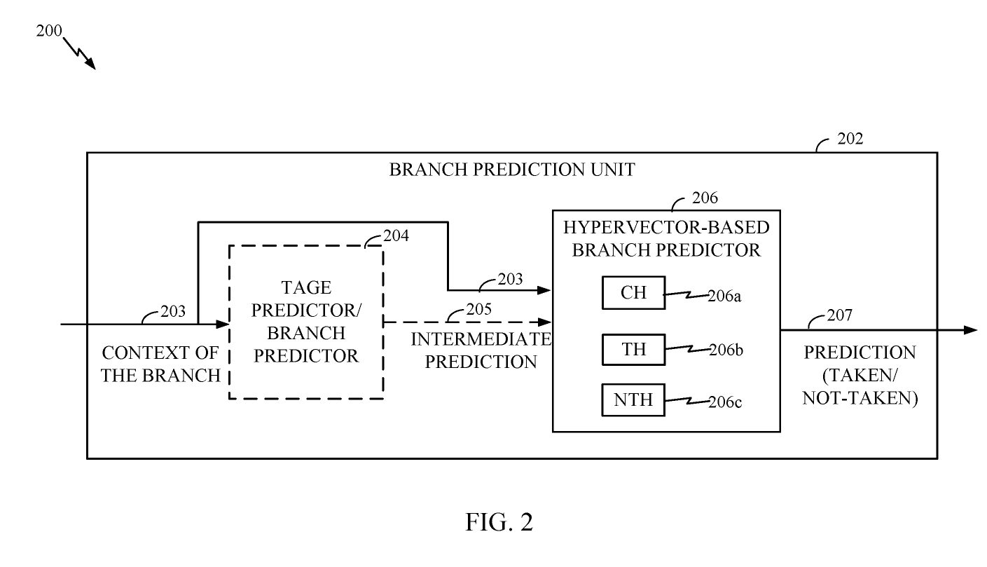

With reference to FIG. 2, an exemplary processing system 200 is shown, with exemplary branch prediction unit 202 specifically illustrated. In branch prediction unit 202, a block designated with the reference numeral 204 and labeled Tage predictor/branch predictor 204 is shown with dashed lines to indicate that this block is optional and when present, may be used in conjunction with exemplary hypervector-based branch prediction mechanisms. Tage predictor 204 (and/or any other branch prediction mechanism known in the art which may be used additionally or alternatively) may be designed according to known techniques previously described.

Branch prediction unit 202 may be employed in a pipeline stage (e.g., fetch stage) of an instruction pipeline (not specifically shown) implemented in processing system 200 and used to obtain predictions for branch instructions, based upon which the branch instructions may be speculatively executed. In this regard, context 203 related to branch instructions which are executed in processing system 200 may be provided to branch prediction unit 202. Context 203 may include multiple dimensions, such as one or more of a program counter (PC) value of the branch instructions, information from a global history register (GHR), local history register (LHR), path history, etc. Intermediate prediction 205 is generated by Tage predictor 204 based on context 203. In exemplary cases which will be described in the following sections, intermediate prediction 205 may be overridden by hypervector-based branch predictor 206 to generate the overall prediction 207 (e.g., taken or not-taken) of branch prediction mechanism 202.

Also shown in branch prediction mechanism 202 is hypervector-based predictor 206. In an exemplary aspect, the multiple dimensions of context 203 may be encoded into a hypervector in hypervector-based branch predictor 206 using various encoding operations. In this disclosure, three fundamental encoding operations, namely, permutation, multiplication, and addition are described, but it will be understood that skilled persons will recognize other encoding operations which may be used without departing from the scope of this disclosure. The permutation operation of a hypervector as described herein comprises rotating the hypervector by a fixed quantity. The multiplication operation performed on two hypervectors comprises performing an XOR operation on each dimension of each of the two hypervectors. The addition operation of two hypervectors comprises performing an addition of each dimension of each of the two hypervectors to form a new hypervector.

The content of context 203 comprising global history register (GHR), local history register (LHR), path history, etc., is more generally said to represent multiple dimensions. Labeling these multiple dimensions with alphanumerical labels such as a, b, c, etc., allows for the following exemplary formulation which may be used in encoding the dimensions a, b, c, etc., into a hypervector.

In an exemplary aspect, a hypervector may be created using a permutation and multiplication operation on dimensions a, b, and c, as represented with the following expression: Hypervector=((a)*b)*c. In the preceding expression, the notation of “(a)” denotes a permutation operation and the “*” operator denotes a multiplication operation.

For combining multiple contexts in the generation of a hypervector, the addition operation may be used, represented by the expression, Hypervector=a+b.

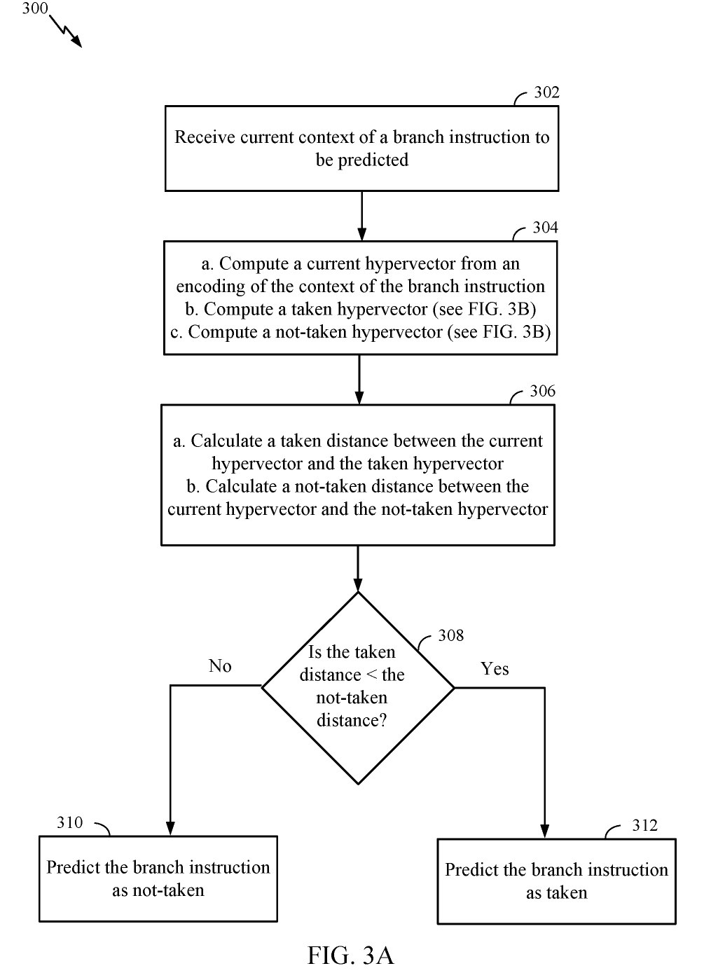

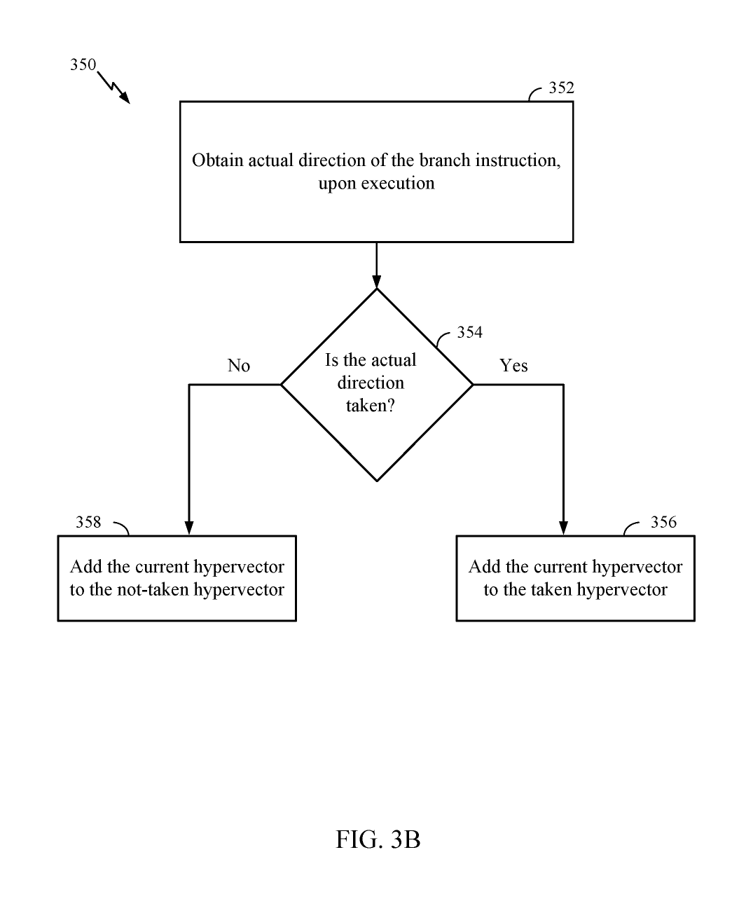

In exemplary aspects, hypervector-based branch predictor 206 is shown to comprise three hypervectors shown as current hypervector (CH) 206a, taken hypervector (TH) 206b, and not-taken hypervector (NTH) 206c. The context of branch instructions, obtained from context 203 is encoded in current hypervector 206a. Context of taken branch instructions is encoded in taken hypervector 206b, and context to not-taken branch instructions is encoded in not-taken hypervector 206c. The cooperation of these three hypervectors 206a-c for obtaining branch predictions, and the processes related to obtaining contexts of taken and not-taken branch instructions to be encoded in taken hypervector 206b and not-taken hypervector 206c will be described with reference to the flowcharts in FIGS. 3A-B below.

With reference to FIG. 3A an exemplary process 300 related to generating a prediction for a branch instruction based on hypervector-based branch predictor 206 is shown.

In Block 302, the current context 203 of a branch instruction to be predicted (i.e., whose direction is to be predicted for speculative execution) is obtained. This context 203 may comprise various dimensions such as a program counter (PC) value of the branch instruction, information from a global history (GHR), local history (LHR), path history, etc. (more generally, dimensions, a, b, c, etc.).

In Block 304, (a) current hypervector 206a is computed from an encoding of context 203 of the branch instruction which was obtained in Block 302. The above-described permutation and multiplication operations may be used to in the encoding to combine the one or more dimensions of context 203 and compute current hypervector 206a; (b) taken hypervector 206b is computed (see, e.g., FIG. 3B, Block 356 for further details); and (c) not-taken hypervector 206c is computed (see, e.g., FIG. 3B, Block 358 for further details).

In Block 306, (a) a taken distance is calculated from current hypervector 206a and taken hypervector 206b, wherein the taken distance may be calculated as a Hamming distance between current hypervector 206a and taken hypervector 206b (as known in the art, the Hamming distance provides a difference between two binary strings or vectors); and (b) a not-taken distance is calculated from current hypervector 206a and not-taken hypervector 206c, wherein, the not-taken distance may be calculated as a Hamming distance between current hypervector 206a and not-taken hypervector 206c.

In Block 308, the taken distance is compared with the not-taken distance (to determine whether current hypervector 206a is closer to taken hypervector 206b or not-taken hypervector 206c).

If the taken distance is less than the not-taken distance, process 300 proceeds to Block 312, wherein prediction 207 is generated as taken for the branch instruction.

On the other hand, if the not-taken distance is less than the taken distance, process 300 proceeds to Block 310, wherein prediction 207 is generated as not-taken for the branch instruction (the case wherein the taken distance is equal to the not-taken distance can result in generating a prediction of taken or not-taken according to specific implementations).

If the optional block 204 of FIG. 2 is present to generate intermediate prediction 205, then in Blocks 312 and 314, prediction 207 generated therein may be compared with intermediate prediction 205. If prediction 207 disagrees or mismatches intermediate prediction 205, then intermediate prediction 205 may be overridden and prediction 207 may be maintained (otherwise, intermediate prediction 205 and prediction 207 are the same and either one may be used in predicting the branch instructions).

With reference now to FIG. 3B, another exemplary process 350 is shown, directed to creating and updating hypervectors 206a-c of hypervector-based branch predictor 206. Process 350 may be performed in conjunction with process 300 as will be understood from the following description.

In Block 352, upon execution of the branch instruction based on prediction 207 obtained in Block 312 or Block 314, an evaluation is obtained (e.g., in a later pipeline stage such as an execution or write back stage of the instruction pipeline, not shown) as to the actual direction of the branch instruction, i.e., taken or not-taken. The actual direction may match prediction 207 (i.e., the branch instruction was correctly predicted) or mismatch prediction 207 (i.e., the branch instruction was mispredicted). Based on the actual direction of the branch instruction, either taken hypervector 206b or not-taken hypervector 206c is updated as follows.

In Block 354, it is determined whether the actual direction of the branch instruction is taken. If it is, process 350 follows the “yes” path to Block 356, wherein current hypervector 206a is combined with taken hypervector 206b, e.g., using an addition operation, to form an updated version of taken hypervector 206b, referred to as a new taken hypervector. This process of combining the current hypervector and the taken hypervector to generate the new taken hypervector is alternatively referred to as encoding the context of taken branch instructions in taken hypervector 206b.

In Block 354, if it is determined that the actual direction of the branch instruction is not-taken, process 350 follows the “no” path to Block 358, wherein current hypervector 206a is combined with not-taken hypervector 206c, e.g., using an addition operation, to form the updated version of not-taken hypervector 206c, referred to as a new not-taken hypervector. This process of combining the current hypervector and the not-taken hypervector to generate the new not-taken hypervector is alternatively referred to as encoding the context of not-taken branch instructions in not-taken hypervector 206c.

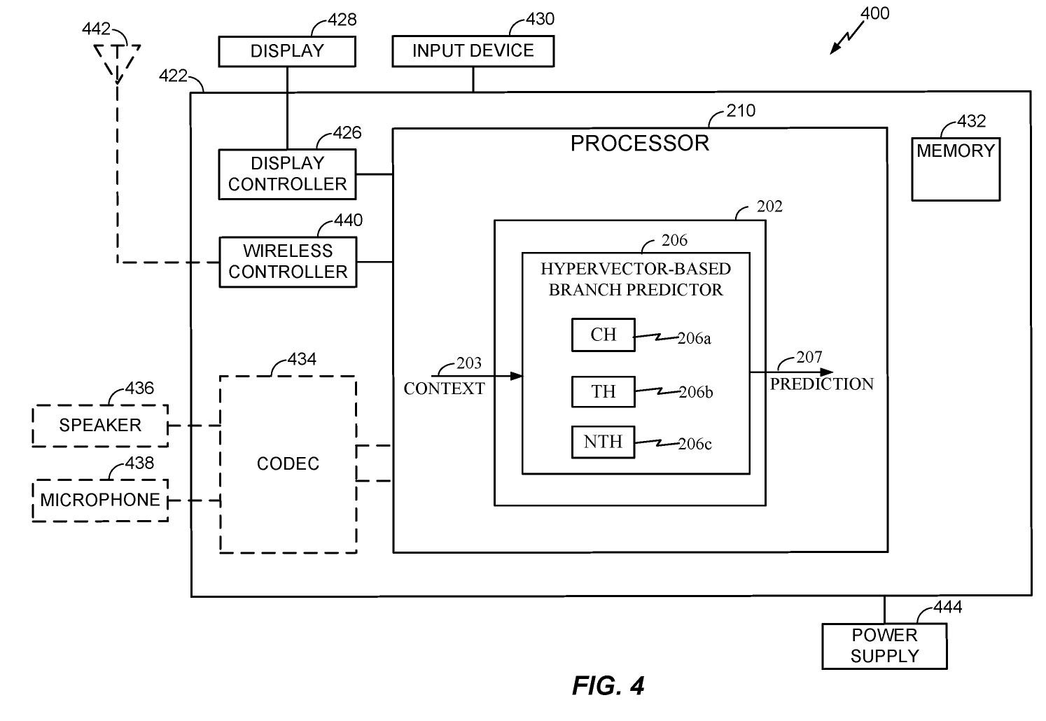

An example apparatus in which exemplary aspects of this disclosure may be utilized, will now be discussed in relation to FIG. 4. FIG. 4 shows a block diagram of computing device 400. Computing device 400 may correspond to an exemplary implementation of a processing system 200 of FIG. 2, wherein processor 210 may be configured for hypervector-based branch prediction in accordance with methods 300 and 350 of FIGS. 3A-B. In the depiction of FIG. 4, computing device 400 is shown to include processor 210, with only limited details of branch prediction unit 202 (including hypervector-based branch predictor 206) shown, for the sake of clarity. Optional block 204 and related aspects which were discussed in the foregoing sections are not shown in this view. Notably, in FIG. 4, processor 210 is exemplarily shown to be coupled to memory 432 and it will be understood that other memory configurations known in the art such as intervening caches have not been shown, although they may be present in computing device 400.

FIG. 4 also shows display controller 426 that is coupled to processor 210 and to display 428. In some cases, computing device 400 may be used for wireless communication and FIG. 4 also shows optional blocks in dashed lines, such as coder/decoder (CODEC) 434 (e.g., an audio and/or voice CODEC) coupled to processor 210 and speaker 436 and microphone 438 can be coupled to CODEC 434; and wireless antenna 442 coupled to wireless controller 440 which is coupled to processor 210. Where one or more of these optional blocks are present, in a particular aspect, processor 210, display controller 426, memory 432, and wireless controller 440 are included in a system-in-package or system-on-chip device 422.

Accordingly, a particular aspect, input device 430 and power supply 444 are coupled to the system-on-chip device 422. Moreover, in a particular aspect, as illustrated in FIG. 4, where one or more optional blocks are present, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-on-chip device 422, such as an interface or a controller.

It should be noted that although FIG. 4 generally depicts a computing device, processor 210 and memory 432, may also be integrated into a set top box, a server, a music player, a video player, an entertainment unit, a navigation device, a personal digital assistant (PDA), a fixed location data unit, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for hypervector-based branch prediction. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

1. A hypervector-based branch prediction method comprising:
for a branch instruction whose direction is to be predicted, determining a taken distance between a current hypervector and a taken hypervector and a not-taken distance between the current hypervector and a not-taken hypervector, wherein the current hypervector comprises an encoding of context of the branch instruction, the taken hypervector comprises an encoding of context of taken branch instructions and the not-taken hypervector comprises an encoding of context of not-taken branch instructions; and
if the taken distance is less than the not-taken distance, generating a prediction of taken for the branch instruction, or if the not-taken distance is less than the taken distance, generating a prediction of not-taken for the branch instruction.

2. The method of claim 1, comprising determining the taken distance based on a Hamming distance between the current hypervector and the taken hypervector.

3. The method of claim 1, comprising determining the not-taken distance based on a Hamming distance between the current hypervector and the not-taken hypervector.

4. The method of claim 1, comprising encoding the context of the branch instruction based on a permutation operation and a multiplication operation to combine one or more dimensions of the context of the branch instruction, for generating the current hypervector.

5. The method of claim 4, wherein the one or more dimensions comprises one or more of a program counter (PC), global history register (GHR), local history register (LHR), or path history.

6. The method of claim 1, further comprising determining an intermediate prediction of the branch instruction from a Tage predictor and overriding the intermediate prediction in executing the branch instruction if the intermediate prediction does not match the prediction based on the taken distance and the not-taken distance.

7. The method of claim 1, further comprising obtaining an actual direction of the branch instruction upon evaluation of the branch instruction to determine whether the actual direction is taken or not-taken.

8. The method of claim 7, wherein encoding of context of taken branch instructions comprises combining the current hypervector and the taken hypervector to generate a new taken hypervector if the actual direction is taken.

9. The method of claim 8, wherein the combining comprises an addition operation of the current hypervector and the taken hypervector.

10. The method of claim 7, wherein encoding of context of not-taken branch instructions comprises combining the current hypervector and the not-taken hypervector to generate a new not-taken hypervector if the actual direction is not-taken.

11. The method of claim 10, wherein the combining comprises an addition operation of the current hypervector and the not-taken hypervector.

12. An apparatus comprising:
a hypervector-based branch predictor comprising:
a current hypervector comprising an encoding of context of a branch instruction whose direction is to be predicted;
a taken hypervector comprising an encoding of context of taken branch instructions; and
a not-taken hypervector comprising an encoding of context of not-taken branch instructions,
wherein the hypervector-based branch predictor is configured to:
determine a taken distance between the current hypervector and the taken hypervector and a not-taken distance between the current hypervector and the not-taken hypervector; and
generate a prediction of taken for the branch instruction if the taken distance is less than the not-taken distance, or a prediction of not-taken for the branch instruction if the not-taken distance is less than the taken distance.

13. The apparatus of claim 12, wherein the taken distance is based on a Hamming distance between the current hypervector and the taken hypervector.

14. The apparatus of claim 12, wherein the not-taken distance is based on a Hamming distance between the current hypervector and the not-taken hypervector.

15. The apparatus of claim 12, wherein the encoding of the context of the branch instruction in the current hypervector comprises a permutation operation and a multiplication operation to combine one or more dimensions of the context of the branch instruction.

16. The apparatus of claim 15, wherein the one or more dimensions comprises one or more of a program counter (PC), global history register (GHR), local history register (LHR), or path history.

17. The apparatus of claim 12, further comprising a Tage predictor to generate an intermediate prediction of the branch instruction, wherein the intermediate prediction is overridden in execution of the branch instruction if the intermediate prediction does not match the prediction generated by the hypervector-based branch predictor.

18. The apparatus of claim 12, wherein encoding of context of taken branch instructions comprises the current hypervector combined with the taken hypervector to generate a new taken hypervector if the actual direction is taken upon evaluation of the branch instruction, and wherein encoding of context of not-taken branch instructions comprises the current hypervector combined with the not-taken hypervector to generate a new not-taken hypervector if the actual direction is not-taken upon evaluation of the branch instruction.

19. The apparatus of claim 12 integrated into a device selected from the group consisting of a set top box, a server, a music player, a video player, an entertainment unit, a navigation device, a personal digital assistant (PDA), a fixed location data unit, a computer, a laptop, a tablet, a communications device, and a mobile phone.

20. A non-transitory computer readable storage medium comprising code, which, when executed by a processor, causes the processor to perform operations for hypervector-based branch prediction, the non-transitory computer readable storage medium comprising:
for a branch instruction whose direction is to be predicted, code for determining a taken distance between a current hypervector and a taken hypervector and a not-taken distance between the current hypervector and a not-taken hypervector, wherein the current hypervector comprises an encoding of context of the branch instruction, the taken hypervector comprises an encoding of context of taken branch instructions and the not-taken hypervector comprises an encoding of context of not-taken branch instructions; and
code for generating a prediction of taken for the branch instruction if the taken distance is less than the not-taken distance, or a prediction of not-taken for the branch instruction if the not-taken distance is less than the taken distance.

21. The non-transitory computer readable storage medium of claim 20, comprising code for determining the taken distance based on a Hamming distance between the current hypervector and the taken hypervector.

22. The non-transitory computer readable storage medium of claim 20, comprising code for determining the not-taken distance based on a Hamming distance between the current hypervector and the not-taken hypervector.

23. The non-transitory computer readable storage medium claim 20, comprising code for encoding the context of the branch instruction based on a permutation operation and a multiplication operation to combine one or more dimensions of the context of the branch instruction, for generating the current hypervector.

24. The non-transitory computer readable storage medium of claim 23, wherein the one or more dimensions comprises one or more of a program counter (PC), global history register (GHR), local history register (LHR), or path history.

25. The non-transitory computer readable storage medium of claim 20, further comprising code for determining an intermediate prediction of the branch instruction from a Tage predictor and code for overriding the intermediate prediction in executing the branch instruction if the intermediate prediction does not match the prediction based on the taken distance and the not-taken distance.

26. The non-transitory computer readable storage medium of claim 20, further comprising code for obtaining an actual direction of the branch instruction upon evaluation of the branch instruction to determine whether the actual direction is taken or not-taken.

27. The non-transitory computer readable storage medium of claim 26, wherein code for encoding of context of taken branch instructions comprises code for combining the current hypervector and the taken hypervector to generate a new taken hypervector if the actual direction is taken.

28. The non-transitory computer readable storage medium of claim 27, wherein the code for combining comprises an addition operation of the current hypervector and the taken hypervector.

29. The non-transitory computer readable storage medium of claim 26, wherein code for encoding of context of not-taken branch instructions comprises code for combining the current hypervector and the not-taken hypervector to generate a new not-taken hypervector if the actual direction is not-taken.

30. (canceled)

31. An apparatus comprising:
a hypervector-based branch predictor comprising:
a first means for an encoding context of a branch instruction whose direction is to be predicted;
a second means for encoding context of taken branch instructions;
a third means for encoding context of not-taken branch instructions;
means for determining a taken distance between the first means and the second means and a not-taken distance between the first means and the third means; and
means for generating a prediction of taken for the branch instruction if the taken distance is less than the not-taken distance or a prediction of not-taken for the branch instruction if the not-taken distance is less than the taken distance.
